(19) United States
(12) Patent Application Publication
(10) Pub. No.: US 2022/0312170 A1
(43) Pub. Date: Sep. 29, 2022

(54) Provision of Message Service Center Address

(71) Applicant: Telefonaktiebolaget LM Ericsson (PUBL), Stockholm (SE)

(72) Inventors: Ralf Keller, Würselen (DE); George Foti, DOLLARD DES ORMEAUX (CA); Jörgen Axell, DANDERYD (SE)

(21) Appl. No.: 17/616,857

(22) PCT Filed: Jun. 6, 2019
(86) PCT No.: PCT/EP2019/064830

§ 371 Date: Dec. 6, 2021

(51) Int. Cl. H04W 4/90; H04W 4/14; H04W 60/04; H04W 4/029

(52) U.S. Cl. CPC H04W 4/90; H04W 4/14; H04W 60/04; H04W 4/029

(57) ABSTRACT

There is provided mechanisms for providing a message service center address. The method is performed by a core network node. The method comprises providing, to a terminal device and as part of performing a registration procedure between a local serving network and the terminal device, a message service center address to terminal device address to a public safety answering point (PSAP) of the local sewing network for an advanced mobile location (AML) service.

### TECHNICAL FIELD

Embodiments presented herein relate to a method, a core network node, a computer program, and a computer program product for providing a message service center address. Embodiments presented herein further relate to a method, a terminal device, a computer program, and a computer program product for obtaining the message service center address.

### BACKGROUND

In general terms, a public-safety answering point (PSAP), sometimes called a “public-safety access point”, might be regarded as a call center responsible for answering calls to an emergency telephone number for police, firefighting, ambulance services, coastguards, search and rescue operations, and the like. Trained telephone operators are commonly responsible for dispatching these emergency services. PSAPs might be capable of caller location for landline calls as well as for mobile terminal locations.

The latter requires that some type of location system is used in order for the PSAP to know the location of the mobile terminal from which the emergency call is originating. Most mobile terminals today support the use of a global navigation system, such as the Global positioning System (GPS), or the like, which can provide a high degree of accuracy for positioning information.

Two options are supported in the technical report (TR) 103 393 from the European Telecommunications Standards Institute (ETSI) for providing improved location information once the mobile terminal has initiated an emergency service, such as an emergency call. In one option a text message, using a short text messaging service (SMS), is sent to the PSAP specific SMS address with location information of the terminal device. Alternatively, and in the second option, a data channel is established between the mobile terminal and the network to send the location information to a public address associated with the PSAP.

Using an SMS to report a location during an emergency service works fine when the terminal is served by its home network since the terminal device would typically be provisioned with the PSAP specific SMS address to use for sending a text message with improved location information when needed. However, there is currently no support for this option when the terminal device is roaming and thus served in a visited network.

Hence, there is still a need for improved mechanisms for using a short text messaging service to report a location during an emergency service.

### SUMMARY

An object of embodiments herein is to provide efficient mechanisms for using an SMS to report a location during an emergency service which do not suffer from the issues noted above, or at least where the above noted issues have been mitigated or reduced.

According to a first aspect there is presented a method for providing a message service center address. The method is performed by a core network node. The method comprises providing, to a terminal device and as part of performing a registration procedure between a local serving network and the terminal device, a message service center address to a public safety answering point (PSAP) of the local serving network for an advanced mobile location (AML) service.

According to a second aspect there is presented a core network node for providing a message service center address. The core network node comprises processing circuitry. The processing circuitry is configured to cause the core network node to provide, to a terminal device and as part of performing a registration procedure between a local serving network and the terminal device, a message service center address to a PSAP of the local serving network for an AML service.

According to a third aspect there is presented a core network node for providing a message service center address. The core network node comprises a provide module configured to provide, to a terminal device and as part of performing a registration procedure between a local serving network and the terminal device, a message service center address to a PSAP of the local serving network for an AML service.

According to a fourth aspect there is presented a computer program for providing a message service center address, the computer program comprising computer program code which, when run on processing circuitry of a core network node, causes the core network node to perform a method according to the first aspect.

According to a fifth aspect there is presented a method for obtaining a message service center address. The method is performed by a terminal device. The method comprises obtaining, from a core network node and as part of performing a registration procedure with a local serving network, a message service center address to a PSAP of the local serving network for an AML service.

According to a sixth aspect there is presented a terminal device for obtaining a message service center address. The terminal device comprises processing circuitry. The processing circuitry is configured to cause the terminal device to obtain, from a core network node and as part of performing a registration procedure with a local serving network, a message service center address to a PSAP of the local serving network for an AML service.

According to a seventh aspect there is presented a terminal device for obtaining a message service center address. The terminal device comprises an obtain module configured to obtain, from a core network node and as part of performing a registration procedure with a local serving network, a message service center address to a PSAP of the local serving network for an AML service.

According to an eight aspect there is presented a computer program for obtaining a message service center address, the computer program comprising computer program code which, when run on processing circuitry of a terminal device, causes the terminal device to perform a method according to the fifth aspect.

According to a ninth aspect there is presented a computer program product comprising a computer program according to at least one of the fourth aspect and the eight aspect and a computer readable storage medium on which the computer program is stored. The computer readable storage medium could be a non-transitory computer readable storage medium.

Advantageously these methods, these core network nodes, these terminal devices, and these computer programs enable efficient use of a short text messaging service to report a location during an emergency service which do not suffer from the issues noted above, or at least where the above noted issues have been mitigated or reduced.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIGS. 2 and 3 are flowcharts of methods according to embodiments;

FIG. 4 is a schematic diagram showing functional units of a core network node according to an embodiment;

FIG. 5 is a schematic diagram showing functional modules of a core network node according to an embodiment;

FIG. 6 is a schematic diagram showing functional units of a terminal device according to an embodiment;

FIG. 7 is a schematic diagram showing functional modules of a terminal device according to an embodiment; and

FIG. 8 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

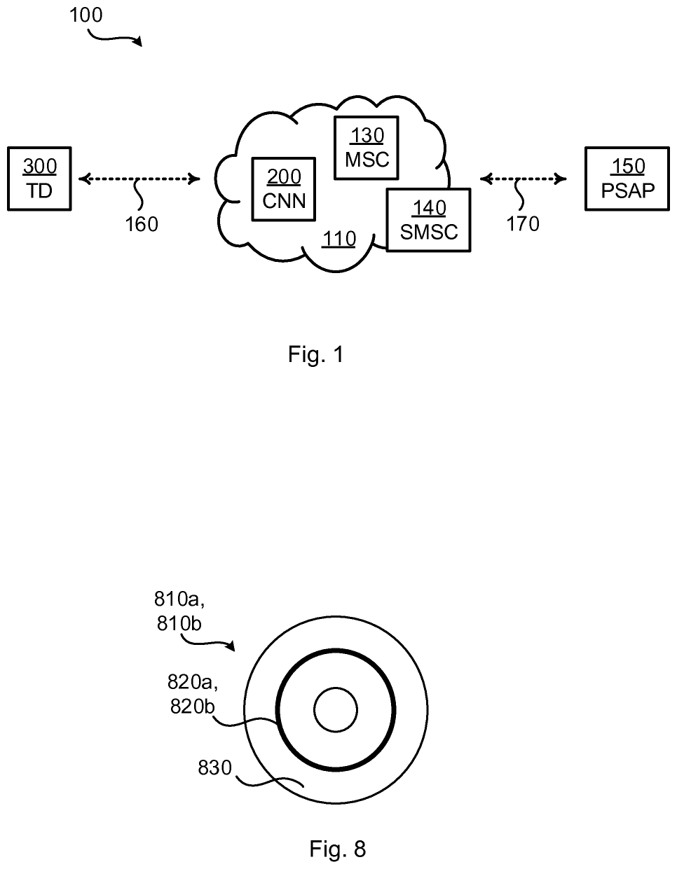

FIG. 1 is a schematic diagram illustrating a communication network 100 where embodiments presented herein can be applied. As the skilled person understands, the communication network 100 of FIG. 1 is simplified compared to a real communication network 100 and show parts most relevant for the present disclosure. The communication network 100 comprises a local serving network 110. The local serving network 110 provides network access to a terminal device (TD) 300. According to non-limiting examples the terminal devices 300 is any of a portable wireless device, mobile station, mobile phone, handset, wireless local loop phone, user equipment (UE), smartphone, laptop computer, tablet computer, wireless modem, wireless sensor device, network equipped vehicle, or Internet of Things (IoT) device.

Depending on the network subscription of the terminal device 300, the local serving network 110 might either be the home network of the terminal device 300 or a visited network. Network access to the terminal device 300 is provided over a wireless radio link 160 which might be established between a radio access network node (not illustrated), or other type of base station, at the network side and the terminal device 300.

The local serving network 110 in turn comprises a core network node (CNN) 200, a mobile switching center (MSC) 130, and a short messaging service center (SMSC) 140. The local serving network 110 is operatively connected over a link 170 (which might be a wireless radio link, a wired link, or a combination thereof) to a PSAP 150. As the skilled person understands, the local serving network 110 might be operatively connected to more than one PSAP 150.

The mobile switching center 130 is mostly associated with communications switching functions, such as call set-up, release, and routing, of the terminal device 300 and thus is configured to route an emergency service, such as an emergency call, originating from the terminal device 300 to the correct PSAP 150, depending on what telephone number is dialled for the emergency service.

The short messaging service center 140 is configured to deliver a message of a short messaging service to the correct PSAP 150, depending on what address used in the message, thus enabling the terminal device 300 to report a location during an emergency service.

There could be different examples of core network nodes 200. In some examples, the core network node 200 is an access management function (AMF)—possible combined with an SMS-Function (SMSF), or a mobility management entity (MME). As the skilled person understands, there might be further core network nodes in the local serving network 110 but those are as such not of particular relevance for the present disclosure and description thereof is therefore omitted for brevity.

As disclosed above there is still a need for improved mechanisms for using a short text messaging service to report a location during an emergency service.

In more detail, if the terminal device 300 is roaming (and thus the local serving network 110 is a visited network) and the use of SMS is initiated for sending improved location information to the PSAP 150 via the short messaging service center 140 during use of an emergency service, the terminal device 300 needs to know the SMS address associated with the PSAP in the visited network since emergency services are handled in the local serving network, which in this case is the visited network. Alternatively, if the terminal device 300 uses SMS to send the improved location information to the home PSAP configured in the terminal device 300, there is currently no way for the home PSAP to forward the improved location information to the visited PSAP.

The embodiments disclosed herein therefore relate to mechanisms for providing a message service center address and obtaining a message service center address. In order to obtain such mechanisms, there is provided a core network node 200, a method performed by the core network node 200, a computer program product comprising code, for example in the form of a computer program, that when run on processing circuitry of the core network node 200, causes the core network node 200 to perform the method. In order to obtain such mechanisms, there is further provided a terminal device 300, a method performed by the terminal device 300, and a computer program product comprising code, for example in the form of a computer program, that when run on processing circuitry of the terminal device 300, causes the terminal device 300 to perform the method.

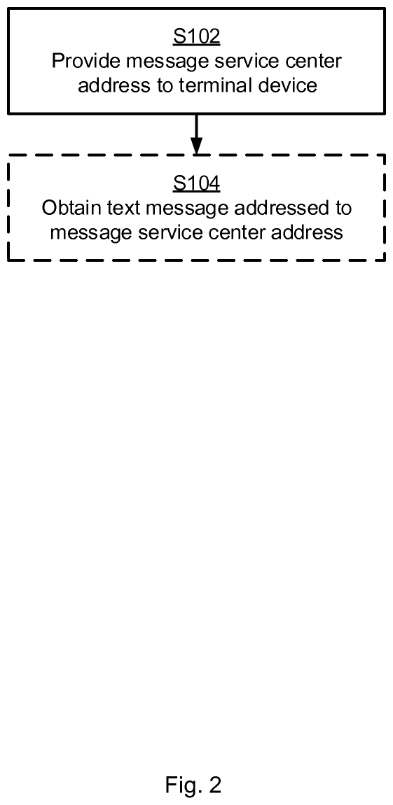

Reference is now made to FIG. 2 illustrating a method for providing a message service center address as performed by the core network node 200 according to an embodiment.

The core network node 200 is configured to perform S102:

S102: The core network node 200 provides, to the terminal device 300 and as part of performing a registration procedure between a local serving network 110 and the terminal device 300, a message service center address. The message service center is to a PSAP 150 of the local serving network 110. The message service center address is for an AML service.

This enables the terminal device 300 that receives the message service center address in a visited network to use the message service center address for an AML service without the need of a separate configuration protocol. Different message service center addresses might be provided for different emergency numbers and for different emergency service Uniform Resource Names (URNs).

Embodiments relating to further details of providing a message service center address as performed by the core network node 200 will now be disclosed.

As will be further disclosed below, the terminal device 300 might use the message service center address when providing AML information in a text message during an emergency service. In particular, according to an embodiment, the core network node 200 is configured to perform (optional) step S104:

S104: The core network node 200 obtains, from the terminal device 300 and during an ongoing emergency service for the terminal device 300 when served by the local serving network 110, a text message. The text message has as address the message service center address. The text message comprises AML information of the terminal device 300.

Further embodiments, aspects, and examples applicable for the core network node 200 will be disclosed below.

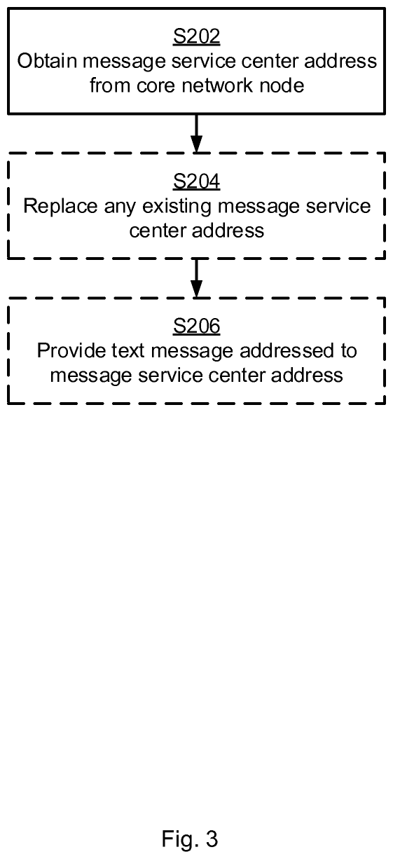

Reference is now made to FIG. 3 illustrating a method for obtaining a message service center address as performed by the terminal device 300 according to an embodiment.

As disclosed above, the core network node 200 provides to the terminal device 300 the message service center address to the PSAP 150 of the local serving network 110 for an AML service. Hence, the terminal device 300 is configured to perform S202:

S202: The terminal device 300 obtains, from the core network node 200 and as part of performing a registration procedure with a local serving network 110, a message service center address. The message service center is to a PSAP 150 of the local serving network 110. The message service center address is for an AML service.

The AML service is to be used by the terminal device 300 when providing location information during an ongoing emergency service. When the terminal device 300 attaches to a network (home network or visited network), it can receive from the network one or more emergency numbers. For each emergency number, it is possible for the network to define an associated local message service center address that the terminal device 300 can use to send AML information when an emergency call is initiated from the terminal device 300. By means of obtaining the message service center address in S202, the terminal device 300 is configured with the address of the correct short message service center 140.

Embodiments relating to further details of obtaining a message service center address as performed by the terminal device 300 will now be disclosed.

In some aspects, the terminal device 300 already has a message service center address for use during an emergency service. However, since it is the current message service center address that is to be used during an emergency service, the terminal device 300 overwrites, discards, or otherwise replaces the existing message service center address for use during an emergency service when having obtained the new message service center address for use during an emergency service as in S202. That is, according to an embodiment, the terminal device 300 is configured to perform (optional) step S204:

S204: The terminal device 300 replaces any existing message service center address for the PSAP 150 of the local serving network 110 for the AML service with the obtained message service center address.

Assuming that an emergency service needs to be initiated from the terminal device 300, for example when an emergency call is set up, the terminal device 300 uses the obtained message service center address for sending AML information in a text message. In particular, according to an embodiment, the terminal device 300 is configured to perform (optional) step S206:

S206: The terminal device 300 provides, to the core network node 200 and during an ongoing emergency service for the terminal device 300 when served by the local serving network 110, a text message. The text message has as address the message service center address. The text message comprises AML information of the terminal device 300.

As noted above, there might be different message service center addresses for different emergency numbers and for different emergency service URNs. In particular, according to an embodiment where there are more than one PSAP 150 in the local serving network 110, each for its own type of emergency service, each PSAP 150 has its own message service center address. One message service center address per PSAP 150 might then in S202 be obtained. Further, which message service center address to use as address for the text message in S206 might depend then on the type of ongoing emergency service. Non-limiting examples of different types of emergency services are police, firefighting, ambulance services, coastguards, search and rescue operations, and the like.

Embodiments, aspects, and examples applicable for both the core network node 200 and the terminal device 300 will be disclosed next.

As noted above, the message service center address is provided (as in S102) and obtained (as in S202) during a registration procedure of the terminal device 300 with the local serving network 110. There could be different types of registration procedures. In some embodiments, the registration procedure is an initial registration procedure for the terminal device 300 or a non-initial registration procedure for the terminal device 300. In further embodiments, the registration procedure is performed as part of a tracking area update (TAU) procedure for the terminal device 300 or during an attach procedure for the terminal device 300. TAU procedures and attach procedures are as such known in the art and further description thereof is therefore omitted for brevity.

There could be different types of message service center addresses. In some embodiments the message service center address is a short message service (SMS) center address or a multimedia message service (MMS) center address. That is, in some aspects the message service center address is an SMS-C address.

There could be different ways to provide the message service center address from the core network node 200 to the terminal device 300 during the registration procedure of the terminal device 300 with the local serving network no. In some embodiments, the message service center address is provided in an information element (IE). In some embodiments the information element is an Extended emergency number list information element.

Two examples of different ways to provide the message service center address from the core network node 200 to the terminal device 300 in an IE based on at least some of the above disclosed embodiments will now be disclosed in detail.

According to the first example, the “Extended emergency number list” IE defined in the third generation partnership project (3GPP) technical specification (TS) 24.301 entitled “Non-Access-Stratum (NAS) protocol for Evolved Packet System (EPS); Stage 3”, version 16.0.0, is extended to include the message service center address.

The terminal device 300, when obtaining this IE from the core network node 300 as part of its registration procedure, stores all SMS-C addresses for AML services and decides for each AML case which SMS-C address to use, depending on the service Uniform Resource Locator (URL) associated with the emergency service.

On purpose of the “Extended emergency number list” IE is to encode one or more local emergency number(s) together with a sub-services field containing zero ore more sub-services of the associated emergency service URN and a validity indication. An emergency service URN is a service URN with top level service type of “sos” as specified in document IETF RFC 5031. If the associated emergency service URN is “urn:service:sos.gas”, there is only one sub-service provided in the sub-services field which is “gas”. If the associated emergency service URN is “urn:service:sos”, there is no sub-services provided in the sub-services field and the length of the sub-services field is “o”. The associated emergency service URN can be a country-specific emergency service URN as defined in 3GPP TS 24.229 entitled “IP multimedia call control protocol based on Session Initiation Protocol (SIP) and Session Description Protocol (SDP); Stage 3”, version 16.1.0.

In aforementioned document 3GPP TS 24.301 the Extended emergency number list IE is coded as shown in figure 9.9.3.37A.1 and table 9.9.3.37A.1, the content of which is duplicated below (where Tbd stands for “to be decided”) as including the message service center address (as one or more SMS-C addresses). The Extended emergency number list IE is a type 6 information element with a minimum length of 6 octets and a maximum length of 65538 octets.

TABLE 1

| 8 | 7 | 6 | 5 | 4 | 3 | 2 | 1 | |
|---|---|---|---|---|---|---|---|---|
| Extended emergency number list IEI | | | | | | | | octet 1 |
| Length of Extended emergency number list IE | | | | | | | | octet 2 |
| contents | | | | | | | | octet 3 |
| 0 | 0 | 0 | 0 | 0 | 0 | 0 | EENLV | octet 4 |

Spare

| Length of 1^{st} Emergency Number information (Note 1) | | octet 5 |
|---|---|---|
| Number digit 2 | Number digit 1 | octet 6 |
| | | (Note 2) |
| Number digit 4 | Number digit 3 | octet 7* |
| . | . | . |
| . | . | . |
| . | . | . |
| (Note 3) | | octet j − 1* |
| Length of 1st sub-services field (Note 4) | | octet j |
| sub-services field | | octet j + 1* |
| | | (Note 5) |
| | | octet k − 1* |
| Length of 1^{st} SMS-C address field | | Tbd |
| SMS-C address field | | Tbd |
| Length of 2^{nd} Emergency Number information | | octet k* |
| (Note 1) | | |
| Number digit 2 | Number digit 1 | octet k + 1* |
| | | (Note 2) |
| Number digit 4 | Number digit 3 | octet k + 2* |
| . | . | |
| . | . | |
| . | . | |
| (Note 3) | . | octet l − 1* |
| | . | |
| | . | |
| Length of 2^{nd} sub-services field (Note 4) | | octet 1* |
| sub-services field | | octet l + 1* |
| | | (Note 5) |
| | | octet m − 1* |
| Length of 2^{nd} SMS-C address field | | Tbd |
| SMS-C address field | | Tbd |
| Length of 3^{rd} Emergency Number information | | octet m* |
| (Note 1) | | |
| Number digit 2 | Number digit 1 | octet m + 1* |
| | | (Note 2) |
| Number digit 4 | Number digit 3 | octet m + 2* |
| . | . | |
| . | . | |
| . | . | |
| (Note 3) | . | octet n − 1* |
| | . | |
| | . | |

| | |
|---|---|
| Length of 3^{rd} sub-services field (Note 4) | octet n* |
| sub-services field | octet n + 1* |
| | (Note 5) |
| | octet 0* |
| Length of 3^{rd} SMS-C address field | Tbd |
| SMS-C address field | Tbd |

(Note 1):
The length might contain the number of octets used to encode the number digit.
(Note 2):
The number digit(s) in octet 6 precedes the digit(s) in octet 7 etc. The number digit, which could be entered first, is located in octet 7, bits 1 to 4. The contents of the number digits might be coded as shown in Table 10.5.118 of document 3GPP TS 24.008, entitled “Mobile radio interface Layer 3 specification; Core network protocols; Stage 3”, version 16.0.0.
(Note 3):
If the emergency number contains an odd number of digits, bits 5 to 8 of the last octet of the respective emergency number might be filled with an end mark coded as “1111”.
(Note 4):
The length might contain the number of octets used to encode the sub-services field.
(Note 5):
The characters of the sub-services of the associated emergency service URN might be coded in accordance to 3GPP TS 23.038, entitled “Alphabets and language- specific information”, version 15.5.0 and the first character starts in octet j + 1, 1 + 1 or n + 1.

According to the second example the message service center address is provided in a separate IE. The terminal device 300, when obtaining this IE from the core network node 300 as part of its registration procedure stores the SMS-C address and uses it for all AML services.

TABLE 2

| | | | | | | | |
|---|---|---|---|---|---|---|---|
| 8 | 7 | 6 | 5 | 4 | 3 | 2 | 1 |

| emergency location address IEI | | octet 1 |
|---|---|---|
| Length of AML Emergency location address IE | | octet 2 |
| contents | | octet 3 |
| Length of first emergency number (Note 1) | | octet 4 |
| Number digit 2 | Number digit 1 | octet 5 |
| | | (Note 2) |
| Number digit 4 | :Number digit 3 | octet 6* |
| (Note 3) | | octet i − 1* |
| Length of first SMS-C address field (Note 4) | | octet i |
| First SMS-C address field (Note 5) | | octet i + 1 |
| | | octet k* |
| Length of n^{th} emergency number | | octet 1* |
| Number digit 2 | Number digit 1 | octet l + 1* |
| Number digit 4 | :Number digit 3 | octet l + 2* |
| (Note 3) | | octet m − 1* |

| | |
|---|---|
| Length of n^{th} SMS-C address field (Note 1) | octet m* |
| n^{th} SMS-C address field (Note 5) | octet m + 1* |
| | octet p* |

(Note 1):
The length might contain the number of octets used to encode the number digit.
(Note 2):
The number digit(s) in octet 5 precedes the digit(s) in octet 6 etc. The number digit, which could be entered first, is located in octet 5, bits 1 to 4. The contents of the number digits might be coded as shown in table 10.5.118 of aforementioned document 3GPP TS 24.008.
(Note 3):
If the emergency number contains an odd number of digits, bits 5 to 8 of the last octet of the respective emergency number might be filled with an end mark coded as “1111”.
(Note 4):
The length might contain the number of octets used to encode the first location address.
(Note 5):
The location address might be encoded as a phone number, equivalent to the emergency numbers.

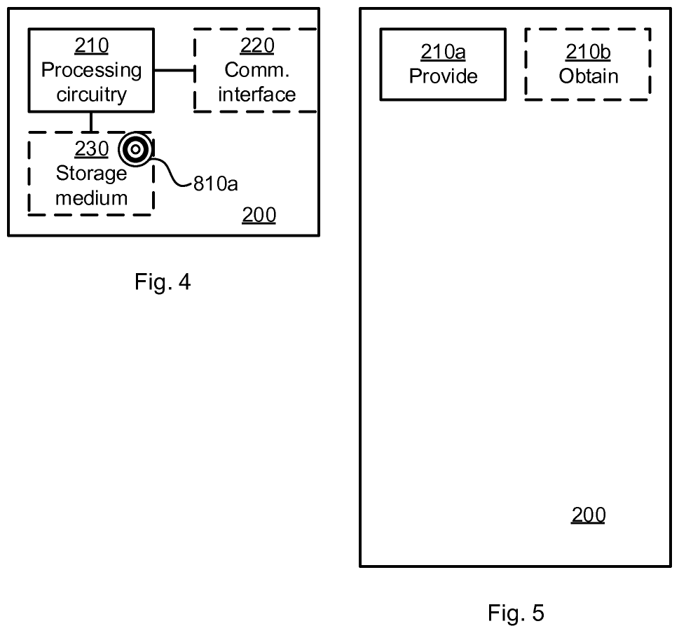

FIG. 4 schematically illustrates, in terms of a number of functional units, the components of a core network node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 810a (as in FIG. 8), e.g. in the form of a storage medium 230. The processing circuitry 210 may further be provided as at least one application specific integrated circuit (ASIC), or field programmable gate array (FPGA).

Particularly, the processing circuitry 210 is configured to cause the core network node 200 to perform a set of operations, or steps, as disclosed above. For example, the storage medium 230 may store the set of operations, and the processing circuitry 210 may be configured to retrieve the set of operations from the storage medium 230 to cause the core network node 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The core network node 200 may further comprise a communications interface 220 for communications with other functions, devices, nodes, and entities of the communication network 100. As such the communications interface 220 may comprise one or more transmitters and receivers, comprising analogue and digital components.

The processing circuitry 210 controls the general operation of the core network node 200 e.g. by sending data and control signals to the communications interface 220 and the storage medium 230, by receiving data and reports from the communications interface 220, and by retrieving data and instructions from the storage medium 230. Other components, as well as the related functionality, of the core network node 200 are omitted in order not to obscure the concepts presented herein.

FIG. 5 schematically illustrates, in terms of a number of functional modules, the components of a core network node 200 according to an embodiment. The core network node 200 of FIG. 5 comprises a provide module 210a configured to perform step S102. The core network node 200 of FIG. 5 may further comprise a number of optional functional modules, such as an obtain module 210b configured to perform step S104. In general terms, each functional module 210a-210b may be implemented in hardware or in software. Preferably, one or more or all functional modules 210a-210b may be implemented by the processing circuitry 210, possibly in cooperation with the communications interface 220 and/or the storage medium 230. The processing circuitry 210 may thus be arranged to from the storage medium 230 fetch instructions as provided by a functional module 210a-210b and to execute these instructions, thereby performing any steps of the core network node 200 as disclosed herein.

The core network node 200 may be provided as a standalone device or as a part of at least one further device. For example, the core network node 200 may be provided in a node of the radio access network or in a node of the core network. Alternatively, functionality of the core network node 200 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time.

Thus, a first portion of the instructions performed by the core network node 200 may be executed in a first device, and a second portion of the instructions performed by the core network node 200 may be executed in a second device; the herein disclosed embodiments are not limited to any particular number of devices on which the instructions performed by the core network node 200 may be executed. Hence, the methods according to the herein disclosed embodiments are suitable to be performed by a core network node 200 residing in a cloud computational environment.

Therefore, although a single processing circuitry 210 is illustrated in FIG. 4 the processing circuitry 210 may be distributed among a plurality of devices, or nodes. The same applies to the functional modules 210a-210b of FIG. 5 and the computer program 820a of FIG. 8.

Examples of core network nodes 300 have been given above.

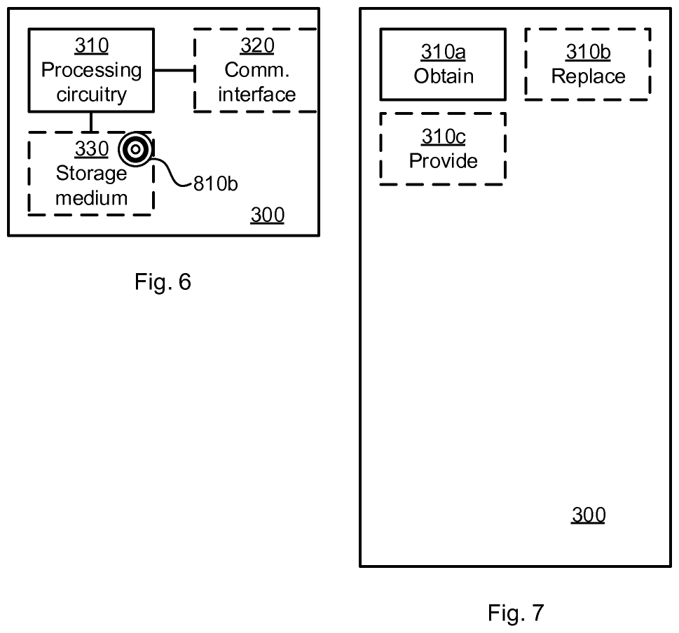

FIG. 6 schematically illustrates, in terms of a number of functional units, the components of a terminal device 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 810b (as in FIG. 8), e.g. in the form of a storage medium 330. The processing circuitry 310 may further be provided as at least one application specific integrated circuit (ASIC), or field programmable gate array (FPGA).

Particularly, the processing circuitry 310 is configured to cause the terminal device 300 to perform a set of operations, or steps, as disclosed above. For example, the storage medium 330 may store the set of operations, and the processing circuitry 310 may be configured to retrieve the set of operations from the storage medium 330 to cause the terminal device 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The terminal device 300 may further comprise a communications interface 320 for communications with other functions, devices, nodes, and entities of the communication network 100. As such the communications interface 320 may comprise one or more transmitters and receivers, comprising analogue and digital components.

The processing circuitry 310 controls the general operation of the terminal device 300 e.g. by sending data and control signals to the communications interface 320 and the storage medium 330, by receiving data and reports from the communications interface 320, and by retrieving data and instructions from the storage medium 330. Other components, as well as the related functionality, of the terminal device 300 are omitted in order not to obscure the concepts presented herein.

FIG. 7 schematically illustrates, in terms of a number of functional modules, the components of a terminal device 300 according to an embodiment. The terminal device 300 of FIG. 7 comprises an obtain module 310a configured to perform step S202. The terminal device 300 of FIG. 7 may further comprise a number of optional functional modules, such as any of a replace module 310b configured to perform step S204 and a provide module 310c configured to perform step S206. In general terms, each functional module 310a-310c may be implemented in hardware or in software. Preferably, one or more or all functional modules 310a-310c may be implemented by the processing circuitry 310, possibly in cooperation with the communications interface 320 and/or the storage medium 330. The processing circuitry 310 may thus be arranged to from the storage medium 330 fetch instructions as provided by a functional module 310a-310c and to execute these instructions, thereby performing any steps of the terminal device 300 as disclosed herein.

Examples of terminal devices 300 have been given above.

FIG. 8 shows one example of a computer program product 810a, 810b comprising computer readable means 830. On this computer readable means 830, a computer program 820a can be stored, which computer program 820a can cause the processing circuitry 210 and thereto operatively coupled entities and devices, such as the communications interface 220 and the storage medium 230, to execute methods according to embodiments described herein. The computer program 820a and/or computer program product 810a may thus provide means for performing any steps of the core network node 200 as herein disclosed. On this computer readable means 830, a computer program 820b can be stored, which computer program 820b can cause the processing circuitry 310 and thereto operatively coupled entities and devices, such as the communications interface 320 and the storage medium 330, to execute methods according to embodiments described herein. The computer program 820b and/or computer program product 810b may thus provide means for performing any steps of the terminal device 300 as herein disclosed.

In the example of FIG. 8, the computer program product 810a, 810b is illustrated as an optical disc, such as a CD (compact disc) or a DVD (digital versatile disc) or a Blu-Ray disc. The computer program product 810a, 810b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Mash memory. Thus, while the computer program 820a, 820b is here schematically shown as a track on the depicted optical disk, the computer program 820a, 820b can be stored in any way which is suitable for the computer program product 810a, 810b.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1.-33. (canceled)

34. A core network node for providing a message service center address, the core network node comprising processing circuitry, the processing circuitry being configured to cause the core network node to:
provide, to a terminal device and as part of performing a registration procedure between a local serving network and the terminal device, a message service center address to a public safety answering point, PSAP, of the local serving network for an advanced mobile location, AML, service;
particularly wherein the core network node is an access management function, AMF, or a mobility management entity, MME;
particularly wherein the message service center address is a short message service, SMS, center address or a multimedia message service, MMS, center address.

35. The core network node according to claim 34, further being configured to:
obtain, from the terminal device and during an ongoing emergency service for the terminal device when served by the local serving network, a text message, the text message having as address the message service center address and comprising AML information of the terminal device.

36. The core network node according to claim 34, wherein the registration procedure is an initial registration procedure for the terminal device or a non-initial registration procedure for the terminal device.

37. The core network node according to claim 34, wherein the registration procedure is performed as part of a tracking area update, TAU, procedure for the terminal device or during an attach procedure for the terminal device.

38. The core network node according to claim 34, wherein the message service center address is provided in an information element, particularly wherein the information element is an Extended emergency number list information element.

39. A terminal device for providing a message service center address, the terminal device comprising processing circuitry, the processing circuitry being configured to cause the insert device 2 name to:
obtain, from a core network node and as part of performing a registration procedure with a local serving network, a message service center address to a public safety answering point, PSAP, of the local serving network for an advanced mobile location, AML, service;
particularly wherein the core network node is an access management function, AMF, or a mobility management entity, MME;
particularly wherein the message service center address is a short message service, SMS, center address or a multimedia message service, MMS, center address.

40. The terminal device according to claim 39, further being configured to:
replace any existing message service center address for the PSAP of the local serving network for the AML service with the obtained message service center address.

41. The terminal device according to claim 39, further being configured to:
provide, to the core network node and during an ongoing emergency service for the terminal device when served by the local serving network, a text message, the text message having as address the message service center address and comprising AML information of the terminal device.

42. The terminal device according to claim 39, wherein the registration procedure is an initial registration procedure for the terminal device or a non-initial registration procedure for the terminal device performed as part of a tracking area update, TAU, procedure for the terminal device or during an attach procedure for the terminal device.

43. The terminal device according to claim 39, wherein the message service center address is provided in an information element, particularly wherein the information element is an Extended emergency number list information element.

44. A method for providing a message service center address, the method being performed by a core network node, the method comprising:
providing, to a terminal device and as part of performing a registration procedure between a local serving network and the terminal device, a message service center address to a public safety answering point, PSAP, of the local serving network for an advanced mobile location, AML, service.

45. The method according to claim 44, further comprising:
obtaining, from the terminal device and during an ongoing emergency service for the terminal device when served by the local serving network, a text message, the text message having as address the message service center address and comprising AML information of the terminal device.

46. A method for obtaining a message service center address, the method being performed by a terminal device, the method comprising:
obtaining, from a core network node and as part of performing a registration procedure with a local serving network, a message service center address to a public safety answering point, PSAP, of the local serving network for an advanced mobile location, AML, service;
particularly wherein the core network node is an access management function, AMF, or a mobility management entity, MME;
particularly wherein the message service center address is a short message service, SMS, center address or a multimedia message service, MMS, center address.

47. The method according to claim 46, further comprising:
replacing any existing message service center address for the PSAP of the local serving network for the AML service with the obtained message service center address.

48. The method according to claim 46, further comprising:
providing, to the core network node and during an ongoing emergency service for the terminal device when served by the local serving network, a text message, the text message having as address the message service center address and comprising AML information of the terminal device.

49. The method according to claim 48, wherein there are more than one PSAP in the local serving network, each for its own type of emergency service, and each having its own message service center address, wherein one message service center address per PSAP is obtained, and wherein which message service center address to use as address for the text message depends on the type of ongoing emergency service.

50. The method according to claim 46, wherein the registration procedure is an initial registration procedure for the terminal device or a non-initial registration procedure for the terminal device.

51. The method according to claim 46, wherein the registration procedure is performed as part of a tracking area update, TAU, procedure for the terminal device or during an attach procedure for the terminal device.

52. The method according to claim 46, wherein the message service center address is provided in an information element, particularly wherein the information element is an Extended emergency number list information element.
